(19) United States
(12) Patent Application Publication
(10) Pub. No.: US 2013/0024297 A1
(43) Pub. Date: Jan. 24, 2013

(54) MARKETING MESSAGE PROVIDING SYSTEM AND METHOD

(71) Applicants: Yung Seong Lee, Seongnam-si (KR); Keonsu Lee, Seongnam-si (KR); Mi Jung Seo, Seongnam-si (KR); Hyoung Gook Lee, Seongnam-si (KR)

(72) Inventors: Yung Seong Lee, Seongnam-si (KR); Keonsu Lee, Seongnam-si (KR); Mi Jung Seo, Seongnam-si (KR); Hyoung Gook Lee, Seongnam-si (KR)

(73) Assignee: NHN BUSINESS PLATFORM CORP., Seongnam-si (KR)

(21) Appl. No.: 13/388,863

(22) PCT Filed: Aug. 4, 2010
(86) PCT No.: PCT/KR10/05122

§ 371 Date: May 15, 2012

(30) Foreign Application Priority Data
Aug. 4, 2009 (KR) 10-2009-0071796
Aug. 4, 2010 (KR) 10-2010-0075371
Aug. 4, 2010 (KR) 10-2010-0075372
Aug. 4, 2010 (KR) 10-2010-0075373
Aug. 4, 2010 (KR) 10-2010-0075374

(51) Int. Cl. G06Q 30/02

(52) U.S. Cl. 705/14.71

(57) ABSTRACT

Disclosed are a marketing message providing system and method. The marketing message providing system is capable of providing a marketing message for inducing the user to access a service of a business owner. Through the marketing message, the user is able to receive targeted information and the business owner is provided with the opportunity in which the user can access the service of the business owner, thereby improving profits.

### CROSS-REFERENCE TO RELATED APPLICATIONS

This application is the National Stage Entry of International Application No. PCT/KR2010/005122, filed on Aug. 4, 2010, and claims priority from and the benefit of Korean Patent Application Nos. 10-2009-0071796, filed on Aug. 4, 2009, 10-2010-0075371, filed on Aug. 4, 2010, 10-2010-0075372, filed on Aug. 4, 2010, 10-2010-0075373, filed on Aug. 4, 2010, and 10-2010-0075374, filed on Aug. 4, 2010, all of which are herein incorporated by reference for all purposes as if fully set forth herein.

### BACKGROUND OF THE INVENTION

1. Field of the Invention

The present invention relates to a marketing message providing system and method, and more particularly, to a system and method that enables a user to access a service of a business owner by providing the user with a marketing message associated with the business owner.

2. Discussion of the Background

Business owners make efforts to promote their services to users. For this, business owners desire to provide users with marketing messages including coupons and the like. To enhance the effect of marketing message delivery, a marketing message needs to be provided to a user most suitable for a service of a corresponding business owner. Accordingly, a business owner desires to target a user most suitable for a service of the business owner and thereby transfer a marketing message to the targeted user.

The present invention proposes a detailed method that may satisfy requirement of a service model as above.

### SUMMARY

The present invention provides a system and method that may efficiently provide a user with a marketing message of a business owner based on targeting information about the user.

An exemplary embodiment of the present invention is directed to a method that may include receiving, from at least one business owner, a bid request including a bid amount and a targeting unit associated with a user to be provided with a marketing message, assigning a weight to the bid amount based on the targeting unit, and determining a business owner to provide the marketing message based on the weighted bid amount.

Another exemplary embodiment of the present invention is directed to a method that may include receiving, from at least one business owner, a purchase request associated with a right to send a marketing message with respect to a user group, and determining a business owner to send the marketing message to the user group based on a cost per sending of the marketing message included in the purchase request.

Still another exemplary embodiment of the present invention is directed to a method that may include providing a marketing message of a business owner to a user based on a targeting condition, and determining a charge amount associated with provision of the marketing message of the business owner based on the targeting condition.

Yet another exemplary embodiment of the present invention is directed to a method that may include providing a sub-business owner with a node page of a node business owner associated with local information, and registering a marketing message of the sub-business owner to the node page based on a partnership between the sub-business owner and the node business owner.

A further another exemplary embodiment of the present invention is directed to a system that may include a bid request receiving unit to receive, from at least one business owner, a bid request including a bid amount and a targeting unit associated with a user to be provided with a marketing message, a weight assignment unit to assign a weight of the bid amount based on the targeting unit, and a business owner determining unit to determine a business owner to provide the marketing message based on the weighted bid amount.

Still another exemplary embodiment of the present invention is directed to a system that may include a purchase request receiving unit to receive, from at least one business owner, a purchase request associated with a right to send a marketing message with respect to a user group, and a business owner determining unit to determine a business owner to send the marketing message to the user group based on a cost per sending of the marketing message included in the purchase request.

Still another exemplary embodiment of the present invention is directed to a system that may include a message providing unit to provide a marketing message of a business owner to a user based on a targeting condition, and a charge amount determining unit to determine a charge amount associated with provision of the marketing message of the business owner based on the targeting condition.

Still another exemplary embodiment of the present invention discloses a system including a node page providing unit to provide a sub-business owner with a node page of a node business owner associated with local information, and a message registering unit to register a marketing message of the sub-business owner to the node page based on a partnership between the sub-business owner and the node business owner.

According to exemplary embodiments of the present invention, it is possible to efficiently provide a user with a marketing message of a business owner based on targeting information about the user.

### BRIEF DESCRIPTION OF THE DRAWINGS

FIG. 1 is a diagram illustrating a process of providing a marketing message according to an exemplary embodiment of the present invention.

FIG. 2 is a block diagram illustrating a configuration of a marketing message providing system according to an exemplary embodiment of the present invention.

FIG. 3 is a diagram illustrating a registering process of a business owner and a user to a marketing message providing system according to an exemplary embodiment of the present invention.

FIG. 4 is a diagram illustrating a bidding process of a business owner with respect to a user group according to an exemplary embodiment of the present invention.

FIG. 5 is a diagram illustrating a bidding process of a business owner through region targeting and user targeting according to an exemplary embodiment of the present invention.

FIG. 6 is a diagram illustrating basic information of a registered marketing message and targeting information according to an exemplary embodiment of the present invention.

FIG. 7 is a diagram illustrating a process of displaying/issuing/sending a marketing message according to an exemplary embodiment of the present invention.

FIG. 8 is a diagram illustrating a process of determining a ranking index of a marketing message according to an exemplary embodiment of the present invention.

FIG. 9 is diagram illustrating an example of displaying a marketing message based on user information and time information according to an exemplary embodiment of the present invention.

FIG. 10 is a diagram illustrating a partnership between business owners according to an exemplary embodiment of the present invention.

FIG. 11 is a flowchart illustrating a bidding process based on a targeting unit according to an exemplary embodiment of the present invention.

FIG. 12 is a flowchart illustrating a purchase process with respect to a user group generated based on a targeting condition according to an exemplary embodiment of the present invention.

FIG. 13 is a flowchart illustrating a process of determining a charge amount to be charged on a business owner based on a targeting condition according to an exemplary embodiment of the present invention.

FIG. 14 is a flowchart illustrating a process of registering a marketing message of a sub-business owner to a node page according to an exemplary embodiment of the present invention.

### DETAILED DESCRIPTION OF ILLUSTRATED EMBODIMENTS

Hereinafter, exemplary embodiments of the present invention will be described in detail with reference to the accompanying drawings.

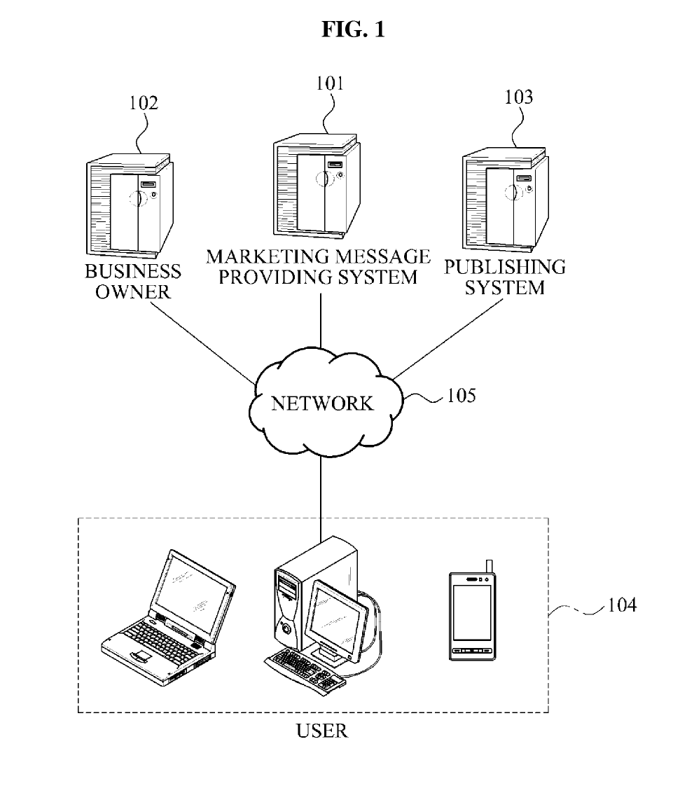

FIG. 1 is a diagram illustrating a process of providing a marketing message according to an exemplary embodiment of the present invention.

In the present invention, a “business owner” may perform activities associated with a marketing message through a business owner system 102, and a “user” may receive the marketing message of the business owner through a user terminal 104 and use the received marketing message. Accordingly, description will be made by setting the business owner system 102 as the “business owner” and by setting the user terminal 104 as the “user”.

A marketing message providing system 101 may provide the user 104 with a marketing message associated with a product or a service of the business owner 102. The marketing message indicates data/message for promoting a product or a service of a business owner, and includes a message that is transferred to the user 104 in a form of a coupon, a ticket, and the like. The marketing message may perform an inducing function of inducing a user to access a product or a service of the business owner 102, or may perform an exchanging function of enabling a user to get a discount when purchasing the product or the service, or to exchange the product or the service free of charge.

The business owner system 102 indicates an entity for performing marketing activities associated with a product/service with respect to a user using the marketing message providing system 101. The user corresponds to a target to receive a marketing message that is provided by the marketing message providing system 101. The user 104 used by the user may be a wired terminal or a wireless terminal.

A network 105 corresponds to a wired/wireless network that performs communication between each system and/or terminal shown in FIG. 1. There is no particular constraint on a communication protocol in which the network is configured.

A publishing system 103 may display a marketing message transferred from the marketing message providing system 101. For example, when the user 104 requests search by inputting a keyword into the publishing system 103, the publishing system 103 may receive a marketing message corresponding to the keyword from the marketing message providing system 101 and display the marketing message for the user 104. Alternatively, when a keyword associated with a marketing message is included in a predetermined text, the publishing system 103 may receive the marketing message corresponding to the keyword from the marketing message providing system 101 and display the marketing message for the user 104 even without a search request.

Meanwhile, the separate publishing system 103 may not necessarily be involved in transferring a message from the marketing message providing system 101 to the user 104. That is, the marketing message providing system 103 may directly transfer a marketing message to the user 104 without using the publishing system 103. The marketing message indicates online or offline data and/or message, such as a flyer, a coupon, a ticket, and the like, for enabling the user 104 to access a product/service of the business owner 102 or for promotion. The marketing message may have an exchange value such as a discount and a free exchange as an attribute value of the marketing message.

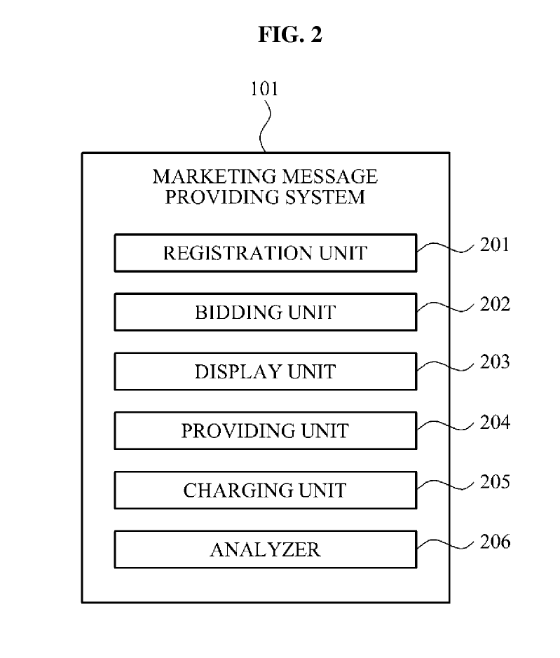

FIG. 2 is a block diagram illustrating a configuration of a marketing message providing system 101 according to an exemplary embodiment of the present invention.

Referring to FIG. 2, the marketing message providing system 101 may include at least one of a registration unit 201, a bidding unit 202, a display unit 203, a providing unit 204, a charging unit 205, and an analyzer 206. Although not illustrated in FIG. 2, each of the registration unit 201, the bidding unit 202, the display unit 203, the providing unit 204, the charging unit 205, and the analyzer 206 may additionally include a detailed constituent element.

<Registration of Business Owner and User>

The registration unit 201 may register a business owner and a user who have joined a service platform associated with a marketing message. Here, the service platform indicates a service of providing a marketing message according to an exemplary embodiment of the present invention. The user and the business owner may be provided with service benefits associated with the marketing message by inputting predetermined information into the service platform. In particular, through registration to the service platform, the business owner may provide a marketing message of the business owner to a targeted user, and the user may receive a marketing message from a targeted business owner.

In the present invention, to transfer the marketing message of the business owner, the business owner and the user may not necessarily need to join the service platform. However, the business owner and the user may be provided with a membership service from the service platform by joining the service platform.

As described above, the marketing message indicates data/message for promoting a product or a service of the business owner, and includes a message transferred to the user in a form of a coupon, a ticket, and the like. The marketing message may perform a function of inducing the user to access the product or the service of the business owner and a function of enabling the user to get discount when purchasing the product or the service of the business owner or to exchange the product or the service free of charge.

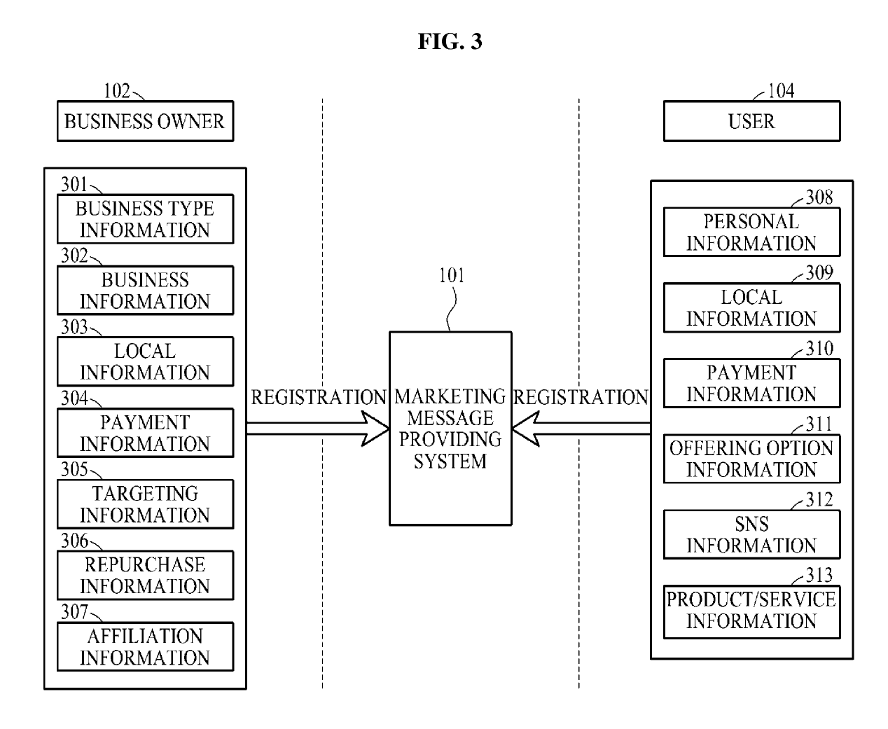

In registration to the service platform, the user and the business owner may input a variety of registration information for marketing as shown in FIG. 3. Detailed registration information will be described with reference to FIG. 3

<Bidding with Respect to Right to Transfer Marketing Message>

The bidding unit 202 may perform bidding associated with issuance/transfer of a marketing message.

For example, a business owner may participate into bidding to obtain a right to send a marketing message with respect to a predetermined user group. Here, the business owner may participate into bidding to secure a right (issuance right) capable of issuing a marketing message for each user group that is generated based on a targeting condition. For example, the business owner may participate into bidding to obtain a right to send a marketing message to a user group that is generated based on a targeting condition including user information such as twenties, Gangnam, and a female, time information such as every Friday, and the like. Also, a business owner who runs bakery may participate into bidding to obtain a right to send a marketing message to a user group that is generated based on a targeting condition such as a male in twenties, 14^{th} of March, 12 o'clock, and a business type category that is limited to bakery.

Alternatively, a user group may be generated based on keyword information that is included in texts prepared by users, such as conversation between users on a social network, comments uploaded by users, bulletin notes, and the like.

That is, when a business owner who participates into bidding for each user group successfully bids, the business owner may enjoy a right capable of issuing a marketing message to a user group exclusively or based on priority. The business owner may more efficiently issue a marketing message by bidding for a user group having a relatively high probability to be targeted for a marketing message of the business owner.

Attribute information of a user to receive the marketing message and attribute information of the business owner may be reflected during the above bidding process. For example, a targeting condition to generate a user group to receive a message may include user profile information, business owner information (type of business), position information of a user to which a marketing message is to be issued, time information about a time when the marketing message is to be issued, the number of users included in the user group, and the like. Based on a targeting condition, a user group may be classified. Issuance costs of a marketing message for each user group may increase according to an addition of a targeting condition set for each user group.

Here, bid elements such as a minimum bid amount required for bidding for a user group and the like may be determined based on the number of users included in the user group, a purchase power index of the user group, and the like.

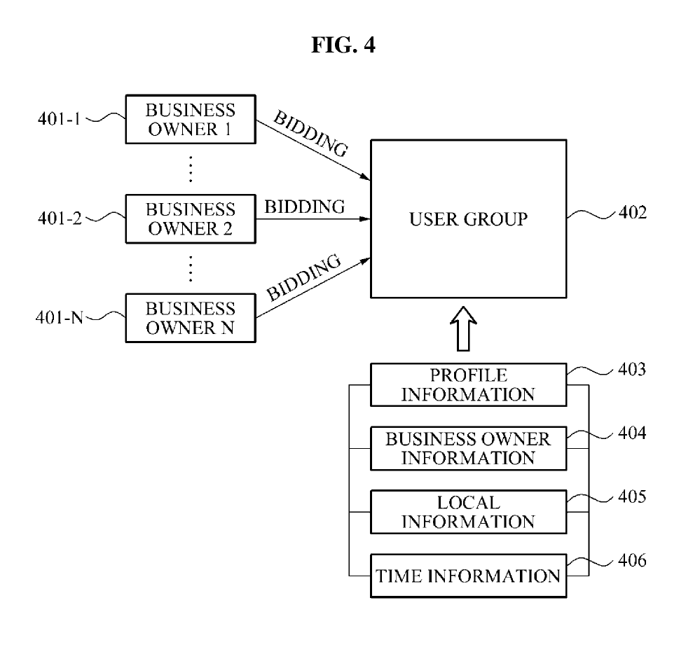

The number of users included in the user group may be set by a marketing message providing system. Also, whether the business owner participates into bidding may be determined based on the number of issuances of a marketing message set by the business owner. A process of the business owner participating into bidding will be further described with reference to FIG. 4.

As described above, it is possible to sell a right to transfer a marketing message to a user group that is generated based on a predetermined standard. In addition, it is possible to sell a right to display an advertisement in response to a predetermined keyword. Through a keyword advertisement purchase, a business owner may transfer a marketing message of the business owner to users.

The business owner may participate into bidding associated with a marketing message by setting a keyword triggering the marketing message to be issued and a targeting unit.

Costs used for selling a keyword advertisement and a right to transfer a marketing message for each user group may be differently set based on information about a message transfer target.

Specifically, when a marketing message is issued to a user through a keyword advertisement that may be displayed for a user in a form of a search advertisement and a contextual advertisement, a business owner may set, as a bid amount, reference cost that the business owner is willing to pay per issuance of the marketing message. Here, the business owner may set a bid amount per issuance of the marketing message to be greater than or equal to a minimum bid amount that is set for each keyword.

In particular, according to an exemplary embodiment of the present invention, a weight may be assigned to a bid amount for each targeting unit set by a business owner. The weight may be directly input by the business owner or may be automatically set based on benefits of the marketing message. Since the weight is assigned based on a targeting unit, a bid amount may be further detailed. Accordingly, with respect to a keyword set by the business owner, bidding may be individually performed based on a targeting unit. Here, weight setting is not limited to a scheme of inputting a reference bid amount and weights. Individual input of a bid amount for each targeting unit also corresponds to the weight setting.

In general, a bid amount is reflected in sorting keyword advertisements and the like and determining a priority. Therefore, setting of a weight for each targeting unit may affect a ranking of a business owner associated with issuance of a marketing message and may also affect a charge amount to be charged on the business owner.

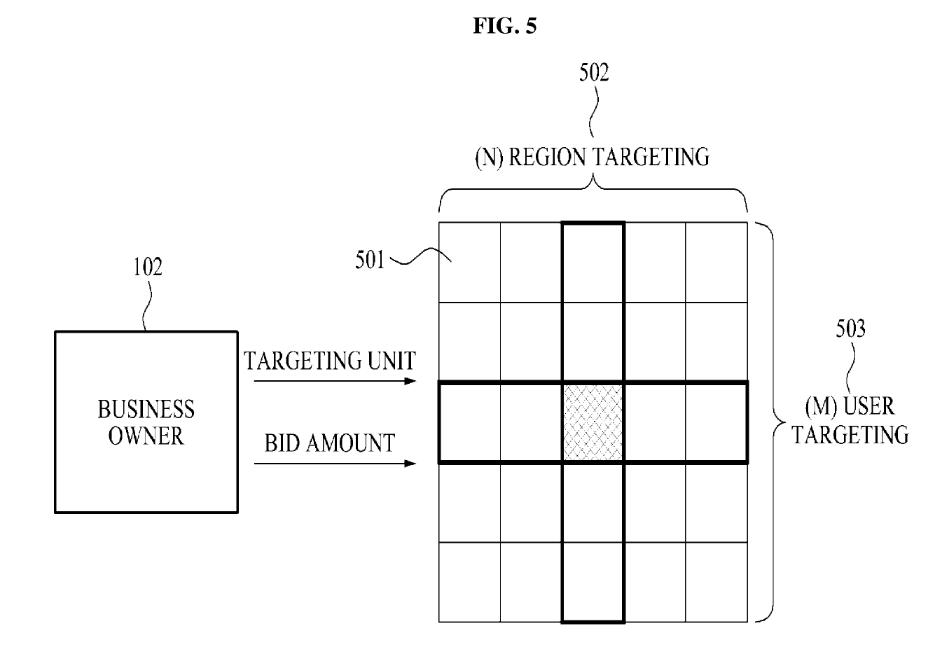

Bidding based on a targeting unit will be further described with reference to FIG. 5.

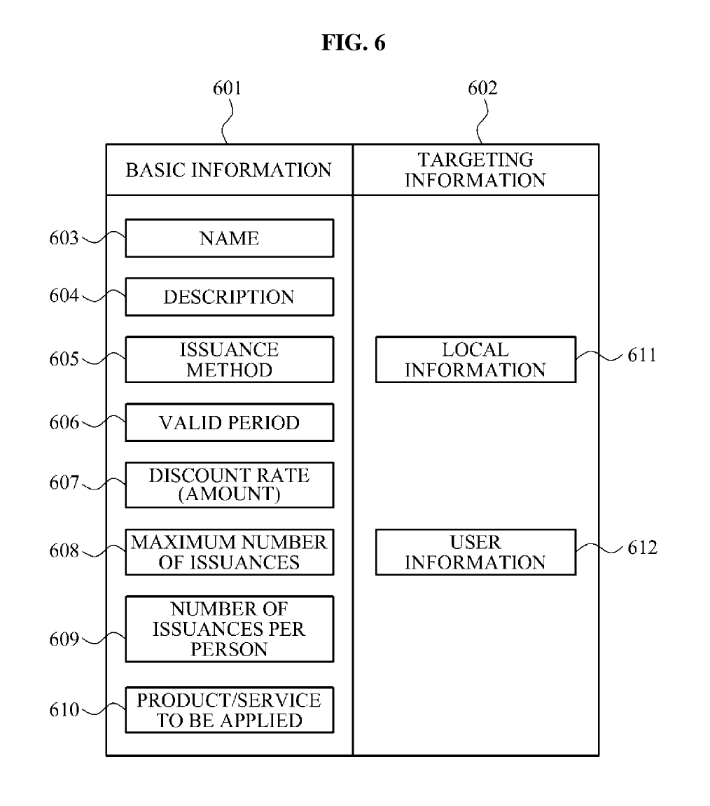

Basic information and targeting information about a marketing message of a business owner who has successfully bid through a bidding process may be stored in a database. The basic information about the marketing message may be generated based on information that is input by the business owner when registering to the service platform. The targeting information about the marketing message may be generated based on a targeting unit or a targeting condition when the business owner bids. The basic information and the targeting information will be further described with reference to FIG. 6.

<Display of Marketing Message>

When targeting information set by a user matches targeting information set by a business owner, the display unit 203 may display a marketing message of the business owner for the user. Here, the display unit 203 may determine a display ranking of the marketing message and sort the marketing message based on the determined display ranking, thereby displaying the marketing message for a user. For example, the display unit 203 may determine a display ranking of the marketing message based on a bid amount set by the business owner, a value index in which a conversion value of the marketing message is reflected, or a quality index associated with targeting information.

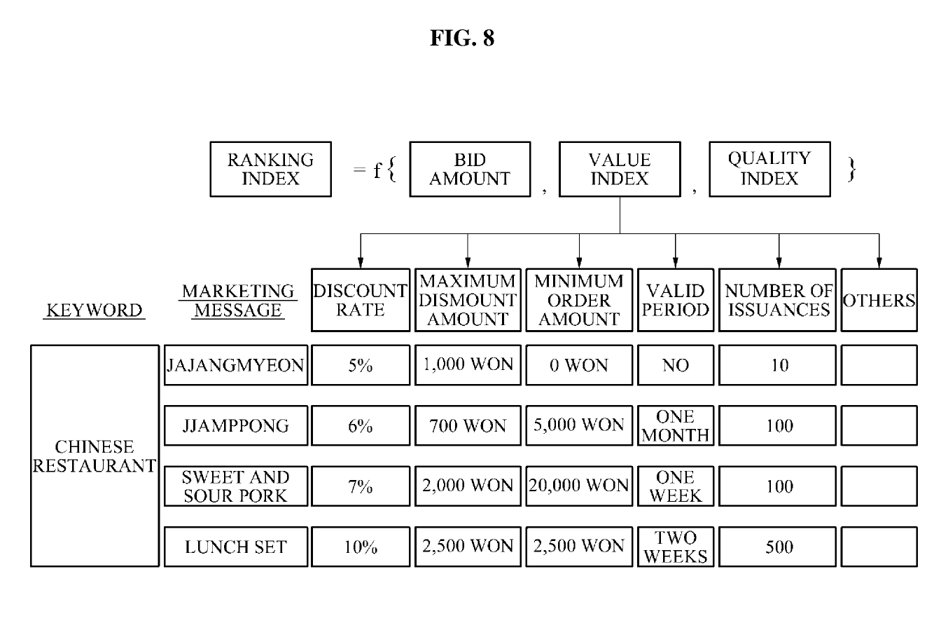

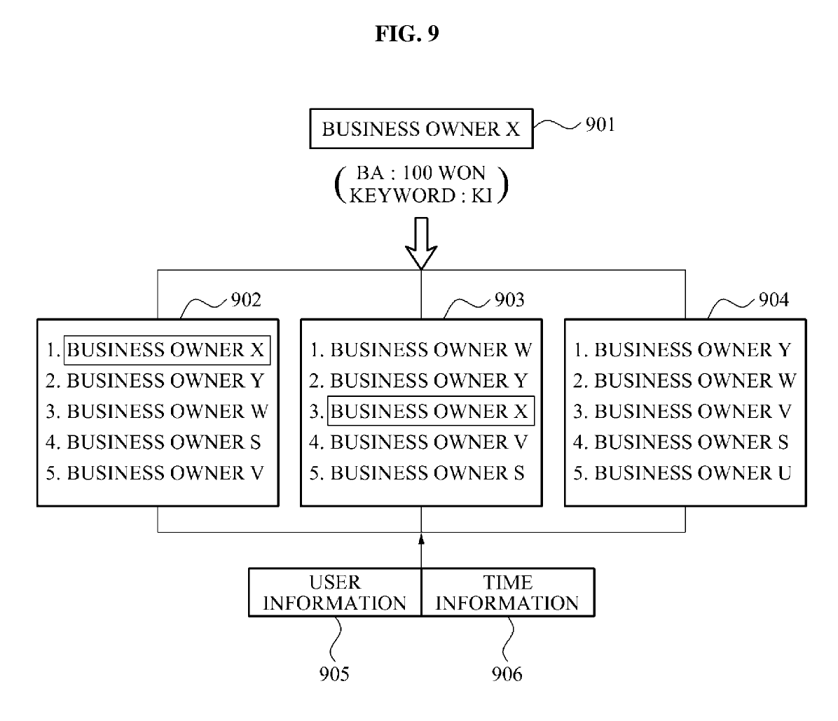

In this instance, the bid amount set by the business owner may indicate a maximum cost that the business owner is willing to pay per issuance of the marketing message. The value index may be determined based on a type of the marketing message and a cash conversion value thereof or targeting information about the user. The quality index may be determined based on conversion information about the marketing message. A process of determining a display ranking of a marketing message will be further described with reference to FIG. 8. Also, a process of differently determining a display ranking based on targeting information will be further described with reference to FIG. 9.

<Provision of Marketing Message>

The providing unit 204 may provide a marketing message of a business owner to a user. The marketing message of the business owner who has successfully bid through a bidding process may be issued to a user that satisfies a targeting condition. Next, the marketing message may be issued to an account of the user and the user may receive the marketing message by downloading or outputting the issued marketing message. Here, the marketing message of the business owner may be sorted and be displayed based on a ranking via a user interface. The user may receive the marketing message by selecting the displayed marketing message.

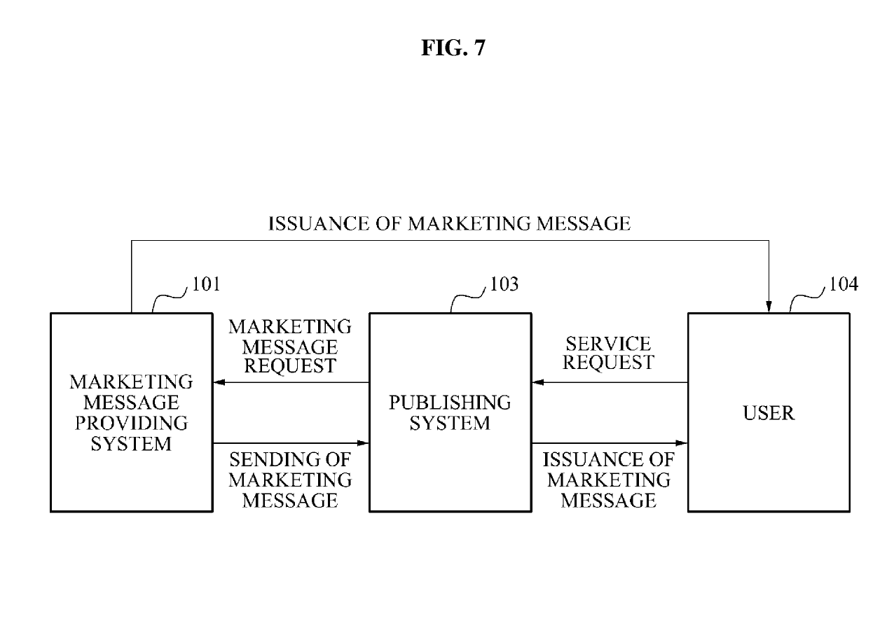

For example, an issuance form of the marketing message may vary based on basic information of the marketing message set by the business owner. A process of providing the marketing message will be further described with reference to FIG. 7.

<Charge Amount for Issuance of Marketing Message>

The charging unit 205 may charge a business owner for issuing a marketing message of the business owner to a user.

For example, the present invention may provide a variety of charging schemes in association with issuance of a marketing message. The charging schemes may include a cost per coupon (CPC), a cost per visit (CPV), a cost per offer (CPO), a cost per affiliate (CPA), a cost per information (CPI), and the like.

The CPC may indicate a scheme of charging per issuance of a marketing message. Here, a minimum cost may be set and the minimum cost may be determined through a bidding process. A charge amount to be charged on the business owner based on the CPC may be determined based on the number of issuances of the marketing message and a value index thereof, or a quality index of the marketing message. The value index may be determined based on a type of the marketing message and a cash conversion value thereof, or targeting information about the user. Also, the quality index may be determined based on conversion information about the marketing message.

The CPV may indicate a scheme of charging every time the user visits a place of business. The CPV may apply a standard fare based on a cost per business type of the business owner and a life time value (LTV) of a customer.

The CPO may indicate a cost for each offer. Specifically, every time the marketing message of the business owner is issued to the user or an offer is sent to the user, the business owner may be charged. When an offer is repeatedly sent to the same user, a sliding system may be applied.

The CPA may indicate a scheme of charging per affiliate. Here, x % of a successful bid cost of a business owner who has requested for being in a corresponding position may be charged based on an affiliation support rate set by the business owner.

The CPI may indicate a scheme of charging per information. Specifically, when the business owner is provided with consulting information about competitive company information, targeting information, and the like through a marketing message providing system, the business owner may be charged with a charge amount based on the CPI.

According to an exemplary embodiment of the present invention, a cost according to displaying/providing of a marketing message may be surcharged or discounted. In particular, in the case of a CPC, to adjust a charge amount per issuance of the marketing message, the charge amount may be differentially determined based on targeting information such as user information, for example, a user profile of a user to which the marketing message is issued or time information about a time when the marketing message is issued.

Specifically, the charge amount may be differentially determined based on a user profile of a user to which the marketing message is issued. Also, the charge amount may be differentially determined based on a correlation between the user to which the marketing message is issued and a product or a service that is a marketing target through the marketing message. Also, the charge amount may be differentially determined based on a probability that the user may use the marketing message at the time when the marketing message is issued.

That is, according to the present invention, the charge amount may be differentially determined based on a target or a time having a relatively high probability with respect to issuance and use of the marketing message. For example, when the marketing message is a beauty shop discount coupon, and when a target of the marketing message is a woman in twenties rather than a teenage girl, a relatively high charge amount may be determined. Cost differentiation with respect to user profile information may be determined based on correlation between a corresponding user and a marketing targeted product/service. The correlation may be induced using various indices such as a purchase power index of a user with respect to the product/service, an interest index, and the like.

When the marketing message is an amusement park discount coupon, and when an issued day of the marketing message is Friday rather than Thursday, a relatively high charge amount may be determined.

As described above, according to the present invention, a weight may be assigned to a bid amount based on targeting information about a user, a display ranking may be adjusted, and a charge amount may be differentially determined.

<Analysis of Effect of Marketing Message>

When a marketing message is issued and thereby is provided to a user, the analyzer 206 may analyze even a final conversion rate. The analyzer 206 may analyze a competition circumstance such as a current offer state and the like. Also, the analyzer 206 may analyze performances such as issuance of a marketing message, offer of the same type of business field/rival company, a business owner affiliate, and the like.

FIG. 3 is a diagram illustrating a registering process of a business owner and a user to a marketing message providing system according to an exemplary embodiment of the present invention.

Referring to FIG. 3, a business owner 102 may join a service platform associated with a marketing message by inputting at least one of business type information 301, business information 302, local information 303, payment information 304, targeting information 305, repurchase information 306, and affiliation information 307.

The business type information 301 indicates a business type category associated with a product or a service provided by the business owner 102. The business information 302 indicates information about benefits provided to a user 104 through the marketing message. For example, when the business owner 102 runs a restaurant, the business information 302 may be “breakfast available”. When the business owner 102 runs a pharmacy, the business information 302 may be “free restorative drink”. The business information 302 may include types of cards capable of providing a discount to the user 104 and the benefit range.

The local information 303 indicates position information about a place of business of the business owner 102 where the marketing message provided to the user 104 may be used. For example, the local information 303 may include an address, a telephone number, a map, a transportation means, and the like, with respect to the place of business.

The payment information 304 indicates a payment means to charge the business owner 102 for issuing a marketing message to the user 104. The payment may be made with cash or a credit card. Alternatively, the payment means may include a scheme of inputting a deposit in advance and subtracting, from the deposit, the number of times that the marketing message is issued to the user 104.

The targeting information 305 indicates information used when the business owner 102 specifies the user 104 for which the marketing message associated with the product or the service is to be displayed. For example, the business owner 102 may target the user 104 for which the marketing message is to be displayed by inputting a region at which the marketing message is to be displayed, a product, a keyword, a user group, a display time, and the like.

The repurchase information 306 indicates benefits to be provided to the user 104 when the user 104 repurchases a product or a service of the business owner 102 through the marketing message. That is, that the user 104 repurchases the product or the service of the business owner 102 indicates that the user 104 is very satisfied with the product or the service and thus, highly probably may continuously repurchase the product or the service of the business owner 102. Accordingly, the business owner 102 may provide benefits to the user 104 who repurchases the product or the service of the business owner 102.

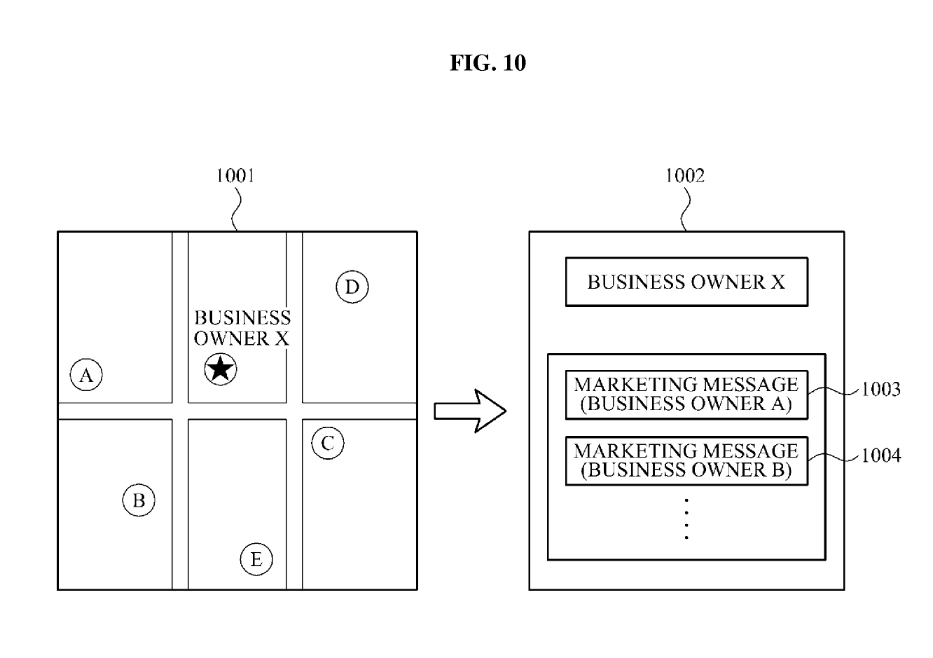

The affiliation information 307 indicates supporting of a register cost to another business owner who requests the business owner 102 to join a page of the business owner 102 associated with a local service. For example, when a business owner B desires to be in a page of a business owner A through affiliation, a marketing message providing system 101 may charge the business owner A with an amount corresponding to x % of a successful bid amount of the business owner B. Here, the business owner B indicates a business owner who has joined a service platform associated with a marketing message according to an exemplary embodiment of the present invention. The business owner A may indicate a business owner who has joined a local service associated with displaying local information of a place of business through the publishing system 103. An affiliation relationship, that is, partnership between business owners will be further described with reference to FIG. 10.

Referring to FIG. 3, the user 104 may join a service platform associated with a marketing message by inputting at least one of personal information 308, local information 309, payment information 310, offering option information 311, social network service (SNS) information 312, and product/service information 313.

The personal information 308 indicates information about a profile of the user 104. For example, the personal information 308 may include information of the user 104 such as a sex, an age, a category of interest, a hobby, an email, an Internet protocol (IP) address, and the like. Also, the marketing message may be provided via a portable terminal and the personal information 308 may include identification (ID) information about a terminal of the user 104, for example, a Media Access Control (MAC) address, a telephone, and the like.

The local information 309 may include a residential area, a working area, a region of interest, and the like, of the user 104. The local information 309 may be input by inputting a name of region or by designating a region using a polygon on a map via a user interface.

The payment information 310 may indicate a payment means used for purchasing a product or a service of a business owner when the user 104 visits a place of business of the business owner through the marketing message.

The offering option information 311 indicates information that is set by the user 104 in association with provision of a marketing message. According to an exemplary embodiment of the present invention, issuance of the marketing message may be separately performed from sending of the marketing message. The marketing message may be issued by adding, to a user account, the marketing message matching targeting information about the user. The marketing message may be sent by transferring (downloading) or outputting the issued marketing message to a user terminal. The user 104 may enable the marketing message matching the personal information 308 or the local information 309 set by the user 104 to be automatically issued, or may set the offering option information 311 for automatically sending the issued marketing message to the user terminal.

The SNS information 312 indicates community information of the user 104. In particular, when the community information interacts with an SNS, information about use of the marketing message may be shared with another user via the SNS. Also, a marketing message may be offered to another user that belongs to the SNS.

The SNS information 312 may include matters that interact with use information of the user 104 on the marketing message on a social network. For example, the user 104 may share a text associated with being provided with a service of a business owner through the marketing message, with another user over a social network. The SNS information 312 may also include such document.

Here, the marketing message providing system may perform mining of a keyword included in a text prepared by the user 104 in a community belonged by the user 104, a keyword or a context included in conversion between the user 104 and another user, and the like, and thereby use the mined keyword as targeting information about the user 104.

The product/service information 313 may indicate a business type or a product/service of the business owner 102 to be provided with a marketing message. The user 104 may be aggressively provided with the marketing message associated with the product or the service of the business owner 102 by setting the product/service information 313.

According to an exemplary embodiment of the present invention, information input by the business owner 102 or the user 104 to join a service platform is not limited to information of FIG. 3. The business owner 102 and the user 104 may be provided with various membership services by joining the service platform.

The business owner 102 may manage business information of the business owner 102 through a service platform. The business owner 102 may manage targeting information about the user 104 through the service platform, and may set a main product/service, benefits for regulars, affiliation support rate, and the like. When the business owner 102 sets the main product/service, the business owner 102 may inform demand of the user 104 who is interested in a corresponding product/service. When the business owner 102 designates benefits for regulars, the service platform performed by the marketing message providing system 101 may provide an additional benefit function to the user 104 who performs repurchase/revisit through the marketing message.

Also, in association with provision of the marketing message, the business owner 102 may look up and charge/refund business money used in the service platform.

The user 104 may look up a marketing message that is issued to the user 104 through a membership function of the service platform, and may send/output the marketing message. The issued marketing message may be sent/output through various media such as a mobile terminal, a personal computer (PC), a printer, and the like.

The user 104 may look up points saved in association with use of a marketing message. When the user 104 receives an offer of a product/service associated with the marketing message, the user 104 may save points corresponding to X % of a cost per offer (CPO) that is set with respect to the business owner 102. When the user 104 immediately or manually receives the marketing message, the user 104 may save points corresponding to X % of a cost per coupon (CPC) that is set with respect to the business owner 102. Also, when the user 104 purchases the product of the business owner 102 or uses a service of the business owner 102 is through the marketing message, the user 104 may save points corresponding to X % of a cost per visit (CPV) or a cost per sale (CPS) that is set with respect to the business owner 102.

Also, the user 104 may register/correct profile information and interest information about personal information of the user 104. The profile information may be used as a targeting condition when the marketing message of the business owner 102 is issued. The interest information may be associated with a business type, business information, and a product/service of the business owner 102. Also, the user 104 may be provided with the marketing message of the business owner 102 that matches a query of interest by inputting the query of interest.

FIG. 4 is a diagram illustrating a bidding process of a business owner with respect to a user group according to an exemplary embodiment of the present invention.

Through a marketing message providing system, business owners 401-1 through 401-N may participate into bidding with respect to a user group to which a marketing message is to be issued. Here, the business owners 401-1 through 401-N may participate into bidding in order to secure a right (an issuance right) capable of issuing a marketing message for each user group 402 that is generated based on a targeting condition.

Referring to FIG. 4, the targeting condition may include profile information 403 of a user, business owner information 404, local information 405, or time information 406. Here, the targeting condition indicates not a condition that is set by the business owners 401-1 through 401-N, but a condition for the marketing message providing system to generate a user group that is a marketing target. The business owners 401-1 through 401-N may participate into bidding with respect to a user group that is generated based on the targeting condition.

The profile information 403 is associated with the personal information 308 input when the user joins a service platform, such as a sex and an age of the user. The business owner information 404 is associated with a business type category of the business owners 401-1 through 401-N, and may be limited when bidding for the user group 402. The local information 405 indicates a region where the user who gets the marketing message issued is positioned. The time information 406 indicates a time at which a marketing message is to be issued.

For example, the business owners 401-1 through 401-N may bid for the user group 402 based on twenties, region A, females, and issuance/sending time that is every Friday. A successfully bid business owner may be assigned with a right capable of issuing a marketing to message of the business owner. When only a single business owner successfully bids for each user group 402, the successfully bid business owner among the business owners 401-1 through 401-N may exclusively issue a marketing message to the user group 402 only during a designated period of time.

When at least one business owner among the business owners 401-1 through 401-N successfully bids, the successfully bid at least one business owner may issue a marketing message to the user group 402 based on a priority that is determined based on a bid amount. For example, when all of marketing messages assigned by a top priority business owner are issued to the user group 402, marketing messages assigned by a second priority business owner may be issued to the user group 402.

Also, the user group 402 may be classified based on a targeting condition. In particular, as a targeting condition set to the user group 402 is added, issuance cost of a marketing message for each user group 402 may increase. As an additional targeting condition is assigned, the marketing message transfer effect may also increase. Therefore, according to the additionally assigned targeting condition, issuance costs of a marketing message for each user group may increase. The above increase in cost may be configured using the same method as a weight assignment according to assignment of an additional targeting condition (condition for generating a marketing target group).

FIG. 5 is a diagram illustrating a bidding process of a business owner through region targeting and user targeting according to an exemplary embodiment of the present invention.

A business owner 102 may participate into bidding associated with a marketing message by setting a keyword triggering the marketing message to be issued. For example, when a search request of a user is input using a keyword, a marketing message of the business owner 102 corresponding to the keyword may be provided, for example, issued/sent to the user. Specifically, when the marketing message is issued to the user through an advertisement associated with the keyword, the business owner 102 may participate into bidding by setting, as a bid amount (BA), a reference bid cost that the business owner is willing to pay per issuance of the marketing message. Here, the business owner 102 may set a bid amount per issuance of a marketing message to be greater than or equal to a minimum bid amount that is set for each keyword.

According to the present invention, the business owner 102 may participate into bidding by additionally setting a targeting unit to a keyword. In addition, according to the present invention, even for the same keyword, different bidding may be performed based on a targeting unit 501. Referring to FIG. 5, the targeting unit 501 is expressed as a matrix form. The targeting unit 501 indicates a minimum unit that enables user targeting for each keyword. The targeting unit 501 may be classified as region targeting 502 and user targeting 503. The region targeting 502 is local information about a region to which a marketing message is to be issued/sent, and indicates local information about a region where the user is positioned. The user targeting 503 indicates a profile of a user to which the marketing message is to be issued/sent, and may be further classified based on a sex and an age of the user.

The business owner 102 may participate into bidding by setting the targeting unit 501 corresponding to the region targeting 502 or the targeting unit 501 corresponding to the user targeting 503. Here, a weight may be assigned to a bid amount for each targeting unit that is set by the business owner 102. A bid amount may vary due to a per-targeting unit weight, which may affect a ranking of a business owner associated with issuance of a marketing message and consequently also affect a charge amount to be charged on the business owner.

When the business owner 102 sets a bid amount with respect to the same keyword, a weight may be differently set based on a targeting unit. For example, when the business owner 102 sets a bid amount of “100 won” with respect to a keyword “restaurant X”, a different weight may be set for each targeting unit as follows. In this case, a bid amount may dynamically vary and thus, a ranking may also dynamically vary when displaying a marketing message.

Targeting unit=male in thirties & weight=150%: When a marketing message is displayed for a male in thirties, a bid amount is calculated as “150” won.

Targeting unit=female in twenties & weight=80%: When a marketing message is displayed for a female in twenties, a bid amount is calculated as “80” won

Targeting unit=teenage boy & weight=0%: When a marketing message is displayed for a teenage boy, a bid amount is calculated as zero won and thus, the marketing message may not be displayed.

A display ranking of a marketing message may be determined for each targeting unit 501. When the targeting unit 501 is not set, or when a superset including at least two targeting units are set, a display ranking of a marketing message may vary compared to when a single targeting unit is set. For example, compared to a bid amount of a business owner Y who bids for the targeting unit 501 in which the region targeting 501 is a region A, a bid amount of a business owner X who bids for the targeting unit 501 in which the region targeting 502 is a region A and the user targeting 503 is a female may be weighted and thus, a marketing message of the business owner X may be displayed in a relatively high ranking.

FIG. 6 is a diagram illustrating basic information of a registered marketing message and targeting information according to an exemplary embodiment of the present invention.

Referring to FIG. 6, basic information 601 of a marketing message may include a name 603, a description 604, an issuance method 605, a valid period 606, a discount rate 607, the maximum number of issuances 608, the number of issuances per person 609, and a product/service to be applied 610. Targeting information 602 of the marketing message may include local information 611 and user information 612.

The basic information 601 of the marketing message indicates a type and a value is of the marketing message, and the like. The name 603 of the marketing message indicates a name of the marketing message set by a business owner, for example, a discount coupon of XXX. The description 604 of the marketing message indicates type or value information indicated by the marketing message, for example, free exchange, discount, saving, and the like. The issuance method 605 indicates media for issuing the marketing message, and any one of online, mobile, and image may be selected as the issuance method 605. The valid period 606 indicates a period of time in which the user can use the marketing message after the marketing message is issued to the user. The discount rate 607 indicates a discount rate applied when the user purchases a product or a service of the business owner through the marketing message. The maximum number of issuances 608 indicates information about the number of times that the marketing message will be issued to users. The number of issuances per user 609 indicates information about the number of times that the marketing message will be issued for each individual user. The product/service to be applied 610 indicates a product or a service of the business owner that the user may purchase through the marketing message.

The local information 611 indicates a region where the user is positioned, in targeting information about displaying of the marketing message. The user information 612 indicates a profile such as a sex and an age of the user in targeting information about displaying of the marketing message.

Basic information and targeting information of a marketing message of a business owner who successfully bids through a bidding process may be stored in a database. The basic information about the marketing message may be generated based on information input when the business owner registers in a service platform. The targeting information about the marketing message may be generated based on a targeting unit or a targeting condition when the business owner bids.

FIG. 7 is a diagram illustrating a process of displaying/issuing/sending a marketing message according to an exemplary embodiment of the present invention.

Referring to FIG. 7, a process of issuing a marketing message may be classified into two processes. The marketing message may be issued to a user 104 through a publishing system 103, or the marketing message may be directly issued from a marketing message providing system 101 to the user 104.

When a targeting condition set by a business owner matches a targeting condition of a user, a marketing message of the business owner may be issued to the user. Targeting information input when the business owner joins a service platform or targeting information set during a bidding process may be set as a targeting condition for providing the marketing message to the user.

The targeting condition may include information about whether the user logs in a service platform, a region where the user is positioned, a demographic characteristic, a purchase power, a purchase rate, a use rate, and a repurchase/revisit rate of the user. Here, the targeting condition is only an example and thus, the present invention is not limited thereto.

When information about whether the user logs in a service platform is set as the targeting condition, a marketing message of the business owner may be provided to a user who logs in the service platform. A region where the user is positioned may be set as a region around a point of interest (POI) on a map or an administrative district such as a street, a district, and a city. The marketing message may be sent to a user positioned in a corresponding region. The demographic characteristic of the user indicates personal information of the user such as an age, a sex, an education background, earnings, a marriage, and the like. The purchase power of the user is associated with an amount of money used to purchase a product of the business owner or use a service of the business owner through the marketing message, and may include information such as the average purchase amount per one time, an LTV, or a maximum purchase amount.

The purchase rate indicates information about whether the user substantially purchased the product of the business owner or used the service thereof compared to that the user is provided with the marketing message. The use rate indicates information about whether the user substantially used the marketing message compared to that the user is provided with the marketing message. The repurchase/revisit rate indicates a purchase history about whether the user repurchased a product or a service of the same business owner or revisited a place of business of the business owner through the marketing message.

Based on the aforementioned targeting condition, the marketing message of the business owner may be provided to the user. The marketing message may also be provided to another user capable of exhibiting the synergy effect based on the targeting condition.

Hereinafter, a process of issuing a marketing message to the user 104 through a publishing system 103 will be described.

The user 104 may request the publishing system 103 such as a portal site, an online shopping mall, and the like, for a service. For example, the user 104 may perform a search by inputting a keyword into the publishing system 103. In response thereto, the publishing system 103 may request the marketing message providing system 101 for a marketing message associated with a search listing corresponding to the keyword. The marketing message providing system 101 may send a marketing message to the publishing system 103. The publishing system 103 may display/issue/send the marketing message to the user 104 together with the search listing corresponding to the keyword.

Hereinafter, a process in which a marketing message is directly issued from the marketing message providing system 101 to the user 104 will be described.

When the user 104 logs in a service platform, the marketing message providing system 101 may directly display/issue/send, to the user 104, a marketing message of a business owner that matches targeting information set by the user 104. That is, the marketing message providing system 101 may provide an offer associated with the marketing message to the user 104 who matches targeting information set by the business owner.

For issuance of a marketing message, the business owner may set an attribute of a marketing message to be issued. The user 104 may set an attribute of a marketing message that the user 104 gets issued. Attributes of the marketing message may be classified as a basic attribute, a constraint attribute, and a price attribute.

The basic attribute may include a type, benefits, a providing form, or a display position of the marketing message. The type of the marketing message may be classified as a marketing message to be issued to the user 104 and a marketing message to be issued for affiliation with another business owner. Benefits of the marketing message may include a discount amount, a discount rate, a free change, and the like.

The providing form of the marketing message may include an authentication number of the marketing message, a message sent to a portable terminal, a paper printed form, and the like. The display position of the marketing message indicates a position on a webpage where the marketing message is displayed for the user 104. The user may get the marketing message issued by selecting a link or a button indicated on the webpage. The marketing message may be provided together with a search listing corresponding to a keyword, or may be provided through a membership page or an affiliate company page.

The constraint attribute may include a use form of the marketing message or whether the marketing message is repeatedly used. In association with the use form, the marketing message may be issued to a portable terminal of the user 104. The marketing message may be displayed on a display device of the portable terminal. The displayed marketing message may be recognized through an optical reader provided on a place of business of the business owner and thereby be used. Alternatively, the marketing message issued to the portable terminal of the user 104 may be output and thereby be used.

In association with the repetitive use, the business owner may set whether the marketing message is one-time usable or n-time usable. When the marketing message is one-time usable, and when the user 104 uses the marketing message once, the marketing message cannot be used anymore and thus, cannot be transferred to another user. When the marketing message is n-time usable, the user 104 may repeatedly use the marketing message ‘n’ number of times. The user 104 may diffuse the marketing message by transferring the n-time marketing message to another user. The other user who receives the n-time marketing message may directly use the marketing message or may transfer the marketing message to still another user. The above use history may be stored in the marketing message providing system 101.

The price attribute may be charged on the business owner in association with displaying/issuing/sending/using of the marketing message. The charging scheme for the marketing message may include a CPC, a CPV, a CPO, a cost per action (CPA), and the like. Also, a surcharge/discount may be applied to the marketing message based on targeting information that is used for issuance/sending. That is, while marketing messages have the identical use value, an expected use rate and marketing effect may be different based on an issuance/sending target of a corresponding marketing message and thus, a different charge amount may be assigned based on targeting information.

A marketing message may be displayed via a user interface together with an online advertisement. For example, an image associated with issuance of the marketing message may be additionally displayed together with a keyword search advertisement. The user 104 may get the marketing message issued or receive the marketing message by selecting the image.

A marketing message may be displayed based on a targeting condition set by a business owner and the user 104.

A business owner may purchase a right capable of offering a marketing message to a user group including a plurality of users 104 through bidding. For example, with respect to is a user group associated with predetermined targeting information, the business owner may be assigned with a right capable of displaying/issuing/sending a marketing message of the business owner to the user group through bidding.

Alternatively, a business owner may display a marketing message of the business owner on a region page of a predetermined node. Here, the predetermined node indicates another business owner who has a partnership with the business owner and indicates a business owner who owns a node page.

A marketing message may be provided to the user 104 by separating issuance and sending. A marketing message of a business owner may be automatically issued/immediately sent to the user 104 based o a condition. When the business owner issues the marketing message, the marketing message may be automatically issued to a user corresponding to targeting information set by the business owner. The user may send or output the automatically issued marketing message in order to use the same.

When the user 104 who has set a business type/business/product/keyword selects “send immediately”, a marketing message may be sent to a device set by the user 104.

The user 104 may send/output a desired marketing message by comparing an issued marketing message with the desired marketing message. For example, the marketing message providing system 101 may send a marketing message corresponding to a payment method that offers the best benefit among payment methods held by the user 104 with respect to the issued marketing message.

When the marketing message is sent, the user 104 may use the marketing message. The use history of the marketing message may be managed for each user 104. Also, when the marketing message is sent, the user 104 may transfer the marketing message to another user. Here, the marketing message may be repeatedly used “n” times. Also, the user 104 may share the marketing message with other users by posting the marketing message to an SNS belonged by the user 104.

Points corresponding to the number of times that the marketing message is used may be saved for the user 104. A marketing message of another business owner who has a partnership with the business owner who has issued the corresponding marketing message may also be issued.

FIG. 8 is a diagram illustrating a process of determining a ranking index of a marketing message according to an exemplary embodiment of the present invention.

A display ranking of a marketing message of a business owner may be determined based on a ranking index. Referring to FIG. 8, the marketing message of the business owner may be displayed in an upper ranking according to an increase in the ranking index. As the marketing message of the business owner is displayed in an upper ranking, a probability that the marketing message may be issued through a user may also increase.

As described above, a bid amount may indicate a maximum cost that the business owner is willing to pay per issuance of the marketing message. The ranking index may be determined to be high according to an increase in a bid amount. Here, a weight may be assigned to a bid amount based on a targeting condition. When a probability that a targeting condition set by the business owner may match a user is high, a relatively high weight may be assigned whereby a bid amount increases. Also, as the targeting condition is further added, a bid amount may be determined to be high. Since a ranking index is determined based on a weighted bid amount, the marketing message of the business owner may be displayed in an upper ranking.

A value index reflects a conversion value of a marketing message and thus, may be determined based on a substantial discount rate, a valid period, the number of issuances, and the like. The actual discount rate relates to benefits provided to the user and thus, may be determined as a maximum discount amount/minimum order amount. The value index may be determined to be high according to an increase in the actual discount rate. The valid period indicates a period of time in which the user who gets the marketing message issued may use the marketing message. According to an increase in the valid period, the valid index may be determined to be high. The number of issuances indicates the number of times that the marketing message of the business owner is issued to the user. According to an increase in the is number of issuances, the value index may be determined to be high.

A quality index may be determined based on a use ratio of a marketing message, an issuance ratio thereof, the number of issuances to the number of lookups, and the like.

The use ratio of the marketing message indicates the number of uses to the number of issuances of the marketing message. That is, the use ratio of the marketing message may be determined to be high when the marketing message is desired information of the user. Therefore, the use ratio of the marketing message may be used as a standard capable of measuring the quality, for example, benefits of the marketing message. Accordingly, the quality index may increase according to an increase in the use ratio of the marketing message whereby the ranking index may increase according to an increase in the quality index.

The issuance ratio of the marketing message indicates the number of issuances to the number of lookups of the marketing message. That is, the issuance ratio of the marketing message is a standard capable of measuring the quality of the marketing message and may be used when it is difficult to measure the use ratio of the marketing message. The quality index may increase according to an increase in the issuance ratio of the marketing message whereby the ranking index may increase according to an increase in the quality index.

FIG. 9 is a diagram illustrating an example of displaying a marketing message based on user information and time information according to an exemplary embodiment of the present invention.

It is assumed that a business owner X 901 has set a bid amount for a keyword K1 as “100 won”. A marketing message listing may be differently determined based on targeting information such as user information 905 or time information 906. The user information 905 may indicate a profile of a user such as a sex, local information, an age, and the like. The time information 906 may indicate information about a point in time when a marketing message is issued.

A marketing message listing 902 indicates a case where a matching probability between the user information 905 or the time information 906 and targeting information set by the business owner X 901 is highest. In the marketing message listing 902, a weight with respect to a marketing message of the business owner X 901 is set to 150% whereby a bid amount is determined as “150 won”. Accordingly, a ranking index increases and the marketing message of the business owner X 901 may be displayed in a top place. A marketing message listing 903 indicates a case where a matching probability between the user information 905 or the time information 906 and targeting information set by the business owner X 901 is relatively low. In the marketing message listing 903, a weight with respect to the marketing message of the business owner X 901 is set to 70% whereby a bid amount is determined as “70 won”. Accordingly, compared to a case where the bid amount is 100 won, the ranking index decreases and the marketing message of the business owner X 901 may be displayed in a third place.

A marketing message listing 904 indicates a case where a matching probability between the user information 905 or the time information 906 and targeting information set by the business owner X 901 barely exists. In the marketing message listing 904, a weight with respect to the marketing message of the business owner X 901 is set to 0% whereby a bid amount is determined as “zero won”. Accordingly, the marketing message of the business owner X 901 may not be displayed for the user.

As described above, a different weight may be applied to a marketing message based on targeting information such as the user information 905 and the time information 906. The ranking index may vary by differentially changing a bid amount based on the weight. Since a charge amount also varies based on a display ranking according to the ranking index, the charge amount may vary in association with earnings that the business owner substantially makes.

FIG. 10 is a diagram illustrating a partnership between business owners according to an exemplary embodiment of the present invention.

According to an exemplary embodiment of the present invention, a node may be set based on partnership between business owners. A level of the node may increase according to an increase in the number of business owners who have the partnership. Affiliation may be made between business owners belonging to different business types and may also be made between business owners having similar targeting information. The affiliation may be made between business owners that are positioned in near distance. A node or any of business owners, not being a node, may offer partnership.

In the present invention, a node indicates a position of a business owner that provides a space capable of transferring a marketing message of the business owner and a marketing message of another business owner to a user in association with provision of local information. Hereinafter, a node business owner indicates a business owner corresponding to the node, and a sub-node business owner indicates a business owner who has partnership with the node business owner and joins a node page.

In association with provision of local information, the node business owner may be determined based on a node index that is determined based on a size of business, awareness, business type representativeness, or the number of affiliate business owners, and reaction information of a user such as a comment, a review, and the like. The node business owner may be highly probably a business owner corresponding to a landmark in a predetermined region. The node index may be recalculated at predetermined time intervals.

As shown in FIG. 10, a node business owner may be indicated as an identifier, for example, an icon capable of drawing a user's attention on a map about a predetermined region. Referring to a map 1001, it can be seen that a business owner X is set as a node business owner. The node business owner may be classified as a level based on popularity, and a display method on the map 1001 may vary based on the level.

Here, a sub-business owner may be a part in a node page of the node business owner through bidding and the like. According to an exemplary embodiment of the present invention, a business owner A and a business owner B are set as sub-business owners of the business owner X. The business owners A and B indicate sub-business owners that are positioned in a near distance from the business owner X and have partnership with the business owner X.

Marketing messages of the business owners A and B, having partnership with the business owner X, may be displayed on a node page 1002 of the business owner X. The business owners A and B may perform bidding to be in a limited node page of the business owner X. Sub-business owners may be a part in the node page of the business owner X in order of a bid amount offered through bidding. Here, the business owners A and B may indicate business owners who have joined a service platform according to an exemplary embodiment of the present invention, and the business owner X may indicate an offline business owner who has nothing to do with the service platform.

That is, a node business owner may issue a marketing message of the business owner to a user through a node page, and a marketing message of a sub-business owner may also be issued to a user through the node page of the node business owner. For example, a user may directly receive a marketing message of a sub-business owner being a part in a node page of a node business owner through the node page. When the user uses the marketing message of the node business owner, a marketing message of the sub-business owner being a part in the node page may also be automatically sent to the user.

A level of a node displayed on a map may increase according to an increase in a node index. According to an increase in the level of the node, an inventory in which a sub-business owner having partnership with the node business owner is capable of being a part in the node page may also increase. According to an increase in the number of sub-business owners that are registered companies, a level of a node corresponding to the node business owner may increase on a map associated with a local service. Accordingly, a probability that the business owner X that is the node business owner may be displayed for users provided with a local service to may increase.

Display versus the advertising effect may be enhanced and thus, earnings of the business owner X may increase. Along with the popularity of the node business owner, sub-business owners being a part of the node page of the node business owner through affiliation with the node business owner may also have increasing marketing activity opportunities. Also, when visiting the node page of the node business owner, users may also obtain information about a sub-business owner positioned around the node business owner and thus, the inconvenience coming from information search may decrease. For example, when a node business owner runs a large move theater and a sub-node business owner runs a coffee shop near the node business owner, a user may obtain a marketing message including discount information and the like together with information about the sub-business owner even though the user visits a node page of the node business owner.

Accordingly, a display opportunity to a user in a local information service through being a part/partnership of a sub-business owner may increase and thus, a node business owner may share earnings with the sub-business owner. Specifically, the node business owner may bear a part of cost used for the sub-business owner to be a part in the node page of the node business owner.

For example, when a support ratio for the business owner A is 10% and a marketing message of the business owner A is successfully bid at 1,000,000 won, a marketing message providing system may charge the node business owner, that is, the business owner X with 100,000 won. In this case, the business owner A that is a sub-business owner may cover 900,000 won.

When a support ratio for the business owner B is 20% and a marketing message of the business owner B is successfully bid at 700,000 won, the marketing message providing system may charge the node business owner, that is, the business owner X with 140,000 won. During a registered period, the marketing message providing system may not charge again a company that has been successfully bid and been a part. The support ratio may be applied during subsequent bidding.

Accordingly, a level of the node business owner may be enhanced on a map of a local information service by setting partnership with sub-business owners. Through this, it is possible to enhance an opportunity capable of displaying business information of the node business owner to users. Through this, along with the popularity of the node business owner, sub-business owners may enhance an opportunity capable of displaying marketing messages of the sub-business owners to users and may save cost associated with displaying of a marketing message by setting partnership with a node.

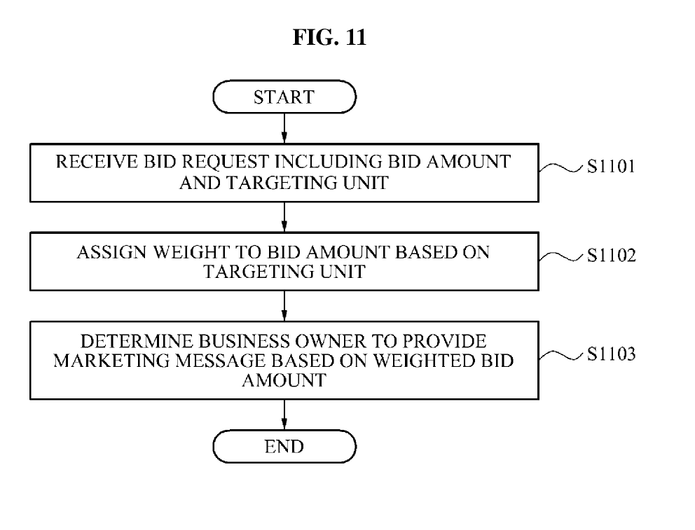

FIG. 11 is a flowchart illustrating a bidding process based on a targeting unit according to an exemplary embodiment of the present invention.

The bidding unit 202 of the marketing message providing system according to an exemplary embodiment of the present invention may include a bid request receiving unit, a weight assignment unit, and a business owner determining unit.

In operation S1101, the bid request receiving unit may receive, from at least one business owner, a bid request including a bid amount and a targeting unit associated with a user to be provided with a marketing message. The marketing message indicates data/message to promote a product or a service of a business owner, and includes a message transferred to a user in a form of a coupon, a ticket, and the like. The marketing message may perform a function of inducing the user to access the product or the service of the business owner and a function of enabling the user to get discount when purchasing the product or the service of the business owner or to exchange the product or the service of the business owner free of charge.

Here, a bid amount may indicate a cost that the business owner is willing to pay per issuance of the marketing message. For example, the bid request receiving unit may receive a bid request for each keyword associated with the marketing message. Specifically, the bid request receiving unit may receive a bid request including a targeting unit that is associated with local information about a region where the user provided with the marketing message is positioned, or profile information of the user.

In operation S1102, the weight assignment unit may assign a weight to the bid amount based on the targeting unit. For example, the weight assignment unit may assign a different weight for each targeting unit that is determined based on at least one of local information and profile information. Since the weight is assigned based on the targeting unit, a bid amount may be further detailed. Accordingly, with respect to a keyword set by the business owner, bidding may be individually performed based on the targeting unit. Also, the weight assignment unit may assign a weight that is input by the business owner, or a weight that is automatically set in association with benefits of the marketing message.

In general, a bid amount may be reflected in sorting keyword advertisements and the like and determining a priority. Therefore, setting of a weight for each targeting unit may affect a ranking of a business owner associated with issuance of a marketing message, and may also affect a charge amount to be charged on the business owner.

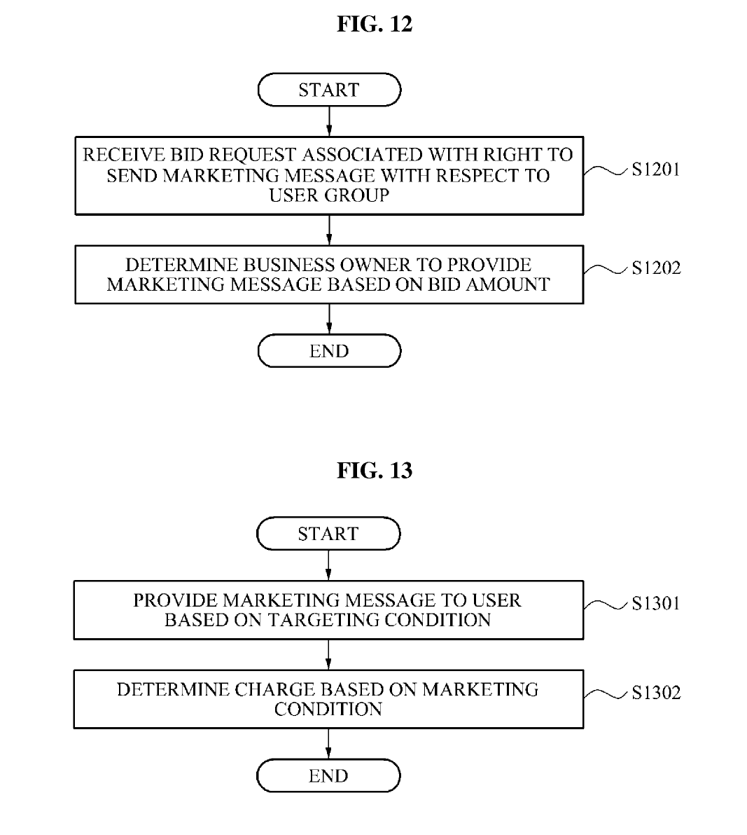

FIG. 12 is a flowchart illustrating a purchase process with respect to a user group generated based on a targeting condition according to an exemplary embodiment of the present invention.

The bidding unit 202 of the marketing message providing system 101 according to an exemplary embodiment of the present invention may include a purchase request receiving unit and a business owner determining unit.

In operation S1201, the purchase request receiving unit may receive, from at least one business owner, a purchase request associated with a right (issuance right) to send a marketing message with respect to a user group. When the right to send the marketing message with respect to the user group is sold in a bidding form, the purchase request may be replaced with a bid request.

Specifically, the purchase request receiving unit may receive a purchase request for each user group that is generated based on at least one targeting condition of user profile information, time information for issuing the marketing message, position information about a position at which the marketing message is to be issued, business type category information of the business owner, and keyword information included in a text prepared in a social network. That is, a user group may be differently generated based on a targeting condition. The targeting condition may be set by the marketing message providing system.

In operation S1202, the business owner determining unit may determine a business owner to send the marketing message to the user group based on a cost per sending of the marketing message included in the purchase request. Here, the cost per sending of the marketing message for the user group may be determined based on a targeting condition associated with the user group. Specifically, since the effect of a marketing message to be provided to a user increases according to an increase in the targeting condition, the cost per sending of the marketing message may also increase.

FIG. 13 is a flowchart illustrating a process of determining a charge amount to be charged on a business owner based on a targeting condition according to an exemplary embodiment of the present invention.

The providing unit 204 of the marketing message providing system 101 according to an exemplary embodiment of the present invention may include a message providing unit.

In operation S1301, the message providing unit may provide a marketing message of a business owner to a user based on a targeting condition. Specifically, a ranking of the marketing message may be differently determined based on the targeting condition. The ranking of the marketing message is described above with reference to FIG. 2.

The charging unit 205 of the marketing message providing system 101 may include a charge amount determining unit.

In operation S1302, the charge amount determining unit may determine charge amount associated with provision of the marketing message of the business owner based on the targeting condition. For example, the charge amount determining unit may differentially determine the charge amount based on profile information of the user that is provided with the marketing message. The charge amount determining unit may differentially determine the charge amount based on correlation between the user and a product or a service that is a marketing target through the marketing message. Here, the correlation may be determined based on at least one of a purchase power index or an interest index of the user provided with the marketing message with respect to the product or the service. Also, the charge amount determining unit may differentially determine the charge amount based on time information about a time when the marketing message is provided.

Accordingly, when the marketing message of the business owner is issued based on a targeting condition having a relatively high user use probability, the charge amount may be determined to be high. On the contrary, when the marketing message of the business owner is issued based on a targeting condition having a relatively low user use probability, the charge amount may be determined to be low.

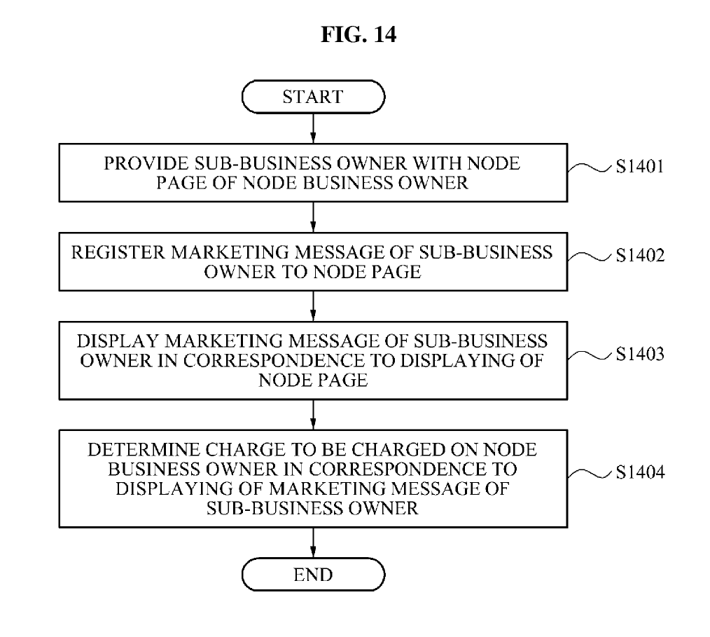

FIG. 14 is a flowchart illustrating a process of registering a marketing message of a sub-business owner to a node page according to an exemplary embodiment of the present invention.

The bidding unit 202 of the marketing message providing system according to an exemplary embodiment of the present invention may include a node page providing unit and a message registration unit.

In operation S1401, the node page providing unit may provide a sub-business owner with a node page of a node business owner associated with local information. Here, the node business owner indicates a business owner having a node page for providing a marketing message of the business owner and a marketing message of a sub-business owner in association with local information. The node business owner may be determined based on a node index that is determined based on a size of business, awareness, business type representativeness, or the number of affiliate business owners and reaction information of a user such as a comment, a review, and the like. The sub-business owner indicates a business owner who has partnership with the node business owner and registers a marketing message to a node page. Here, registering the marketing message is a concept corresponding to that the sub-business owner is a part in the node page.

In operation S1402, the message registration unit may register a marketing message of the sub-business owner to the node page based on a partnership between the sub-business owner and the node business owner.

The display unit 203 of the marketing message providing system 101 according to an exemplary embodiment of the present invention may include a message display unit.

In operation S1403, the message display unit may display the marketing message of the sub-business owner in correspondence to displaying of the node page.

The charging unit 205 of the marketing message providing system 101 according an exemplary embodiment of the present invention may include a charge amount determining unit.

In operation S1404, the charge amount determining unit may determine a charge amount to be charged on the node business owner in correspondence to displaying of the marketing message of the sub-business owner. For example, the charge amount determining unit may determine a charge amount to be charged on the node business owner based on a registration support ratio of the node page set by the sub-business owner.

Things not described above with reference to FIGS. 11 through 14 may refer to description made above with reference to FIGS. 1 through 10.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method that uses a processor, the method comprising:
receiving, from at least one business owner, a bid request comprising a bid amount and a targeting unit associated with a user to be provided with a marketing message;
assigning a weight to the bid amount based on the targeting unit; and
determining, using the processor, a business owner to provide the marketing message based on the weighted bid amount.

2. The method of claim 1, wherein the bid amount comprises a cost to be paid by the business owner per issuance of the marketing message.

3. The method of claim 1, wherein receiving comprises receiving the bid request for each keyword associated with the marketing message.

4. The method of claim 1, wherein receiving comprises receiving the bid request comprising the targeting unit associated with local information about a region at which the user provided with the market message is positioned, or profile information of the user.

5. The method of claim 4, wherein assigning comprises differently assigning a weight for each targeting unit comprising at least one of the local information and the profile information.

6. The method of claim 1, wherein assigning comprises differently assigning a weight that is input by the business owner or a weight that is automatically set in association with benefits of the marketing message.

7. A method that uses a processor, the method comprising:
receiving, from at least one business owner, a purchase request associated with a right to send a marketing message with respect to a user group; and
determining, using the processor, a business owner to send the marketing message to the user group based on a cost per sending of the marketing message in the purchase request.

8. The method of claim 7, wherein receiving comprises receiving the purchase request for each user group that is generated based on at least one targeting condition of user profile information, time information for issuing the marketing message, position information about a position at which the marketing message is to be issued, business type category information of the business owner, and keyword information in a text prepared in a social network.

9. The method of claim 8, wherein receiving comprises determining a cost per sending of the marketing message that is set for the user group based on a targeting condition associated with the user group.

10. A method that uses a processor, comprising:
providing a marketing message of a business owner to a user based on a targeting condition; and
determining, using the processor, a charge amount associated with provision of the marketing message of the business owner based on the targeting condition.

11. The method of claim 10, wherein determining comprises differentially determining the charge amount based on profile information of the user that is provided with the marketing message.

12. The method of claim 10, wherein determining comprises differentially determining the charge amount based on correlation between the user and a product or a service that is a marketing target through the marketing message.

13. The method of claim 12, wherein the correlation is determined based on at least one of a purchase power index or an interest index of the user provided with the marketing message with respect to the product or the service.

14. The method of claim 10, wherein determining comprises differentially determining the charge amount based on time information about a time when the marketing message is provided.

15. A method that uses a processor, the method comprising:
providing a sub-business owner with a node page of a node business owner associated with local information; and
registering, using the processor, a marketing message of the sub-business owner to the node page based on a partnership between the sub-business owner and the node business owner.

16. The method of claim 15, further comprising:
displaying the marketing message of the sub-business owner in correspondence to displaying of the node page.

17. The method of claim 16, further comprising:
determining a charge amount to be charged on the node business owner in correspondence to displaying of the marketing message of the sub-business owner.

18. The method of claim 15, wherein:
the node business owner is a business owner who has a node page for providing a user with the marketing message of the node business owner and the marketing message of the sub-business owner in association with local information, and
the sub-business owner is a business owner who has a partnership with the node business owner and registers the marketing message to the node page.

19. The method of claim 18, further comprising determining the node business owner based on a node index comprising business owner quality information comprising a size of business, awareness, business type representativeness, or the number of affiliate business owners, and reaction information of a user associated with provision of local information.

20. The method of claim 17, wherein determining comprises determining the charge amount to be charged on the node business owner based on a registration support rate of the node page set by the sub-business owner.

21. A non-transitory computer-readable medium comprising an executable program, which when executed, instructs a computer to perform the method according to claim 1.

22-41. (canceled)
